(19) United States
(12) Patent Application Publication
(10) Pub. No.: US 2024/0203452 A1
(43) Pub. Date: Jun. 20, 2024

(54) DISK HUB FOR RETAINING AND ROTATING MAGNETIC RECORDING MEDIA DURING FILM THICKNESS MEASUREMENT

(71) Applicant: Western Digital Technologies, Inc., San Jose, CA (US)

(72) Inventors: Qi Sun, San Jose, CA (US); David William Oswald, Morgan Hill, CA (US)

(21) Appl. No.: 18/228,835

(22) Filed: Aug. 1, 2023

Related U.S. Application Data
(60) Provisional application No. 63/433,086, filed on Dec. 16, 2022.

(51) Int. Cl. G11B 5/66; G11B 5/10; G11B 25/04

(52) U.S. Cl. CPC G11B 5/66; G11B 5/102; G11B 25/043; G11B 5/8408

(57) ABSTRACT

A disk hub is configured to retain a magnetic recording medium including an annulus shape and a layer configured for magnetic recording. The disk hub includes a base plate portion for supporting an inner diameter area of the magnetic recording medium and a stem portion on the base plate portion. The base plate portion is configured to support the inner diameter area of the magnetic recording medium. The stem portion includes a first section with a frustoconical shape and a second section extending between the first section and the base plate portion. A circumference of the second section increases in a direction away from the base plate portion, and a circumference of the first section decreases in the direction away from the base plate portion. The disk hub includes an electrostatic dissipative material. The electrostatic dissipative material can be infused with carbon nanotubes.

### CROSS REFERENCE TO RELATED APPLICATIONS

This application claims priority to and the benefit of U.S. Provisional Application No. 63/433,086, entitled “DISK HUB FOR RETAINING AND ROTATING MAGNETIC RECORDING MEDIA DURING FILM THICKNESS MEASUREMENT,” filed Dec. 16, 2022, the entire content of which is incorporated herein by reference as if fully set forth below in its entirety and for all applicable purposes.

### FIELD

The present disclosure relates generally to information storage devices, and in particular, a disk hub for retaining and rotating a magnetic recording medium during a process for characterizing a film thickness on the magnetic recording medium.

### INTRODUCTION

Computer systems and various electronic devices can use magnetic storage devices for storing data and information. To read and/or write data, a magnetic storage device (e.g., a hard disk drive) can employ a recording head (e.g., slider) that flies above the surface of a rotating magnetic recording medium in close proximity. The magnetic recording medium may have a lubricant film formed on the media surface to protect the magnetic recording medium and the recording head (e.g., from potential contact events therebetween). In some examples, the lubricant film may be formed by a lubricant such as a perfluoropolyether (PFPE) class lubricant. A PFPE lubricant can provide excellent tribological and contamination robustness for hard disk media applications. The thickness of a lubricant film is often a parameter of interest in magnetic recording media manufacturing processes (e.g., lubrication processes). In some examples, it may be helpful to control the PFPE lubricant film thickness to a high level of accuracy (e.g., one-tenth angstrom scale level).

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One aspect of the disclosure provides a disk hub for retaining a magnetic recording medium including an annulus shape and a layer configured for magnetic recording. The disk hub includes a base plate portion configured to support an inner diameter area of the magnetic recording medium. The disk hub further includes a stem portion on the base plate portion and configured to extend into a circular opening of the magnetic recording medium. The stem portion includes a first section with a frustoconical shape and a second section extending between the first section and the base plate portion. A circumference of the second section increases in a direction away from the base plate portion, and a circumference of the first section decreases in the direction away from the base plate portion.

One aspect of the disclosure provides a method of manufacturing a disk hub for retaining a magnetic recording medium including an annulus shape and a layer configured for magnetic recording. The method forms the disk hub using a thermoplastic polymer. The method provides a base plate portion configured to support an inner diameter area of the magnetic recording medium. The method further provides a stem portion on the base plate portion and configured to extend into a circular opening of the magnetic recording medium. The stem portion includes a first section with a frustoconical shape and a second section extending between the first section and the base plate portion. A circumference of the second section increases in a direction away from the base plate portion, and a circumference of the first section decreases in the direction away from the base plate portion.

One aspect of the disclosure provides a disk hub for retaining a magnetic recording medium including an annulus shape and a layer configured for magnetic recording. The disk hub includes a base plate portion for supporting an inner diameter area of the magnetic recording medium. The disk hub further includes a stem portion on the base plate portion and configured to extend into a circular opening of the magnetic recording medium. The disk hub includes an electrostatic dissipative material.

These and other aspects of the disclosure will become more fully understood upon a review of the detailed description, which follows. Other aspects, features, and implementations of the disclosure will become apparent to those of ordinary skill in the art, upon reviewing the following description of specific implementations of the disclosure in conjunction with the accompanying figures. While features of the disclosure may be discussed relative to certain implementations and figures below, all implementations of the disclosure can include one or more of the advantageous features discussed herein. In other words, while one or more implementations may be discussed as having certain advantageous features, one or more of such features may also be used in accordance with the various implementations of the disclosure discussed herein. In a similar fashion, while certain implementations may be discussed below as device, system, or method implementations, it should be understood that such implementations can be implemented in various devices, systems, and methods.

### BRIEF DESCRIPTION OF THE DRAWINGS

FIG. 1 is a top schematic view of a disk drive configured for magnetic recording including a slider and a magnetic recording medium in accordance with one aspect of the disclosure.

FIG. 2 is a side schematic view of the slider and magnetic recording medium of FIG. 1 in accordance with one aspect of the disclosure.

FIG. 3 is a side schematic view of a magnetic recording medium in accordance with one aspect of the disclosure.

FIG. 4 is a block diagram conceptually illustrating an apparatus for measuring the film thickness of a magnetic recording medium in accordance with one aspect of the disclosure.

FIG. 5 is a diagram conceptually illustrating a surface of the magnetic recording medium shown in FIG. 4 in accordance with one aspect of the disclosure.

FIG. 6 is a diagram conceptually illustrating a side view and a top view of a disk hub according to one aspect of the disclosure.

FIG. 7 is a diagram providing top and bottom perspective views of a disk hub according to one aspect of the disclosure.

FIG. 8 is a diagram illustrating a top view and a side view of the disk hub of FIG. 7 according to one aspect of the disclosure.

FIG. 9 is a diagram illustrating a first section (section A-A) of the disk hub of FIG. 7 according to one aspect of the disclosure.

FIG. 10 is a diagram illustrating a second section (section B-B) of the disk hub of FIG. 7 according to one aspect of the disclosure.

FIG. 11 is a diagram illustrating an enlarged area of the disk hub of FIG. 9 according to one aspect of the disclosure.

FIG. 12 is a diagram illustrating a magnetic recording medium placed on the base plate portion of the disk hub according to one aspect of the disclosure.

FIG. 13 is a diagram illustrating the disk hub connected to a coupler of a film thickness measurement apparatus according to one aspect of the disclosure.

FIG. 14 is a flowchart illustrating a process for measuring a film thickness of a magnetic recording medium in accordance with some aspects of the disclosure.

FIG. 15 is a flowchart illustrating a process for manufacturing a disk hub in accordance with some aspects of the disclosure.

### DETAILED DESCRIPTION

In the following detailed description, reference is made to the accompanying drawings, which form a part thereof. In addition to the illustrative aspects, aspects, and features described above, further aspects, aspects, and features will become apparent by reference to the drawings and the following detailed description. The description of elements in each figure may refer to elements of proceeding figures. Like numbers may refer to like elements in the figures, including alternate aspects of like elements.

The disclosure relates in some aspects to a disk hub for retaining and positioning a magnetic recording medium and a method for characterizing a film thickness on the magnetic recording medium using the disk hub. The magnetic recording medium may be used in various data storage devices (e.g., hard disk drive or disk array).

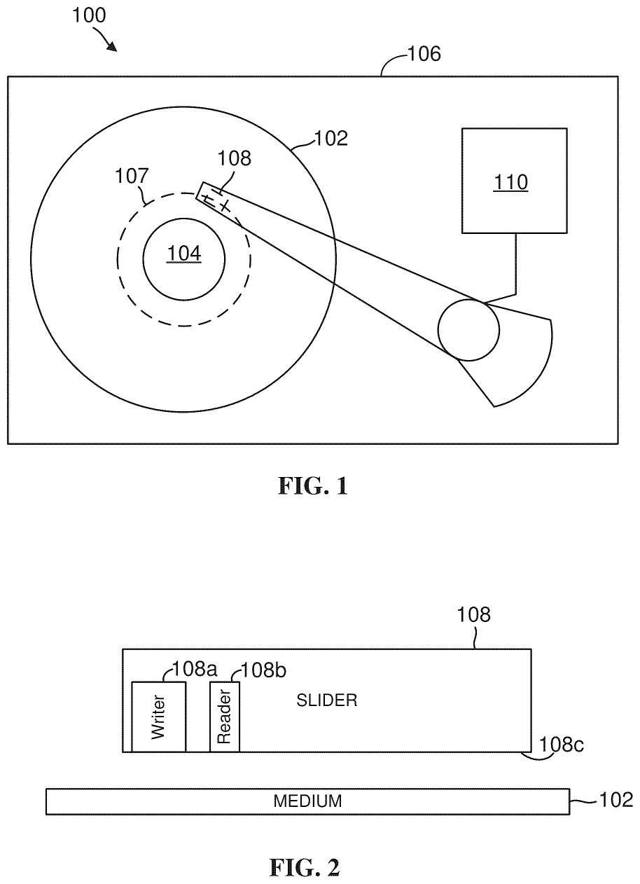

FIG. 1 is a top schematic view of a data storage device 100 (e.g., disk drive or magnetic recording device) configured for magnetic recording including a slider 108 and a magnetic recording medium 102 according to one or more aspects of the disclosure. The data storage device 100 may include one or more disks/media 102 to store data. The disk/media 102 resides on a spindle assembly 104 that is mounted to a drive housing 106. Data may be stored or recorded along tracks in the magnetic recording layer of disk 102. The reading and writing of data are accomplished with the recording head 108 (slider) that may have both write element (e.g., writer 108a) and read element (e.g., reader 108b). The write element 108a is used to alter the properties of the magnetic recording layer of disk 102 and thereby write information thereto. In one aspect, the head 108 may have magneto-resistive (MR) based elements, such as tunnel magneto-resistive (TMR) elements for reading, and a write pole with coils that can be energized for writing. In operation, a spindle motor (not shown) rotates the spindle assembly 104, and thereby rotates the disk 102 to position the head 108 at a particular location along a desired disk track 107. The position of the head 108 relative to the disk 102 may be controlled by the control circuitry 110 (e.g., a microcontroller). Some embodiments of the data storage device 100 are HAMR (heat assisted magnetic recording), EAMR (energy assisted magnetic recording), or non-EAMR magnetic data recording systems, including perpendicular magnetic recording (PMR) and shingled magnetic recording (SMR) disk drives.

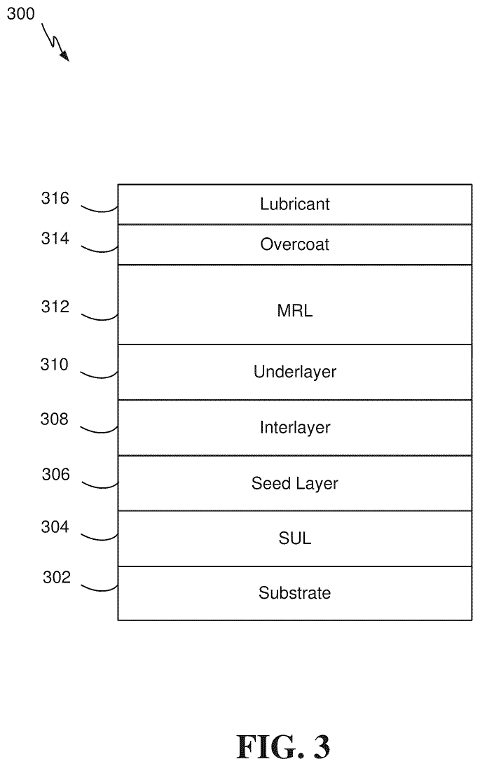

FIG. 2 is a side schematic view of the slider 108 and magnetic recording medium 102 of FIG. 1. The magnetic recording medium 102 may have a lubricant layer (e.g., lubricant layer 316 shown in FIG. 3) in accordance with one or more aspects of the disclosure. The slider 108 includes a write element (e.g., writer) 108a and a read element (e.g., reader) 108b positioned along an air bearing surface (ABS) 108c of the slider for writing information to, and reading information from, respectively, the media 102.

FIG. 3 is a side schematic view of a magnetic recording medium 300 in accordance with one aspect of the disclosure. In some embodiments, the magnetic recording medium 300 may be configured for PMR. In other embodiments, the structures, systems, and/or methods described herein (to measure a film (e.g., lubricant) thickness) can be used with other media types including those configured for SMR, MAMR, HAMR, etc. The magnetic recording medium 300 has a stacked structure with a substrate 302 at a bottom/base layer (not shown), an amorphous soft magnetic underlayer (SUL) 304 on the substrate 302, a seed layer 306 on the SUL 304, an interlayer 308 on the seed layer 306, an underlayer 310 on the interlayer 308, a magnetic recording layer (MRL) 312 on the underlayer 310, an overcoat layer 314 on the MRL 312. In some embodiments, the medium 300 may have a lubricant layer 316 on the overcoat layer 314. In some aspects, the substrate 302 may be made of one or more materials such as an Al alloy, NiP plated Al, glass, glass ceramic, and/or combinations thereof. In one embodiment, the substrate 302 may be a rigid substrate (e.g., glass or ceramic).

In some aspects, the amorphous SUL 304 may be made of materials with high permeability, high saturation magnetization and low coercivity such as CoFe, and one or more elements selected from the group consisting of Mo, Nb, Ta, W, B, Zr, and combinations thereof. In some aspects, the seed layer 306 may be made of any suitable materials known in the art. The seed layer 306 has a certain lattice structure and crystallographic orientation that can determine the crystallographic orientation of a layer (e.g., interlayer 308) grown/deposited on the seed layer 306. In one embodiment, the seed layer 306 may be made of Ni alloys. In some aspects, the MRL 312 may be made of a CoPt alloy with or without additional other elements or oxides. In some aspects, the MRL 312 may be made of FePt or an alloy selected from FePtX, where X is a material selected from Cu, Ni, and combinations thereof. In some examples, the crystallographic orientation of the MRL 312 can facilitate PMR, SMR, MAMR, and/or HAMR. In some aspects, the overcoat layer 314 may be made of carbon.

The terms “above,” “below,” “on,” and “between” as used herein refer to a relative position of one layer with respect to other layers. As such, one layer deposited or disposed on, above, or below another layer may be directly in contact with the other layer or may have one or more intervening layers. Moreover, one layer deposited or disposed between layers may be directly in contact with the layers or may have one or more intervening layers.

The lubricant layer 316 can provide protection to the magnetic recording medium 300 and/or the slider 108 during read/write operations when the slider 108 flies at a close distance (e.g., down to about 1 nm) over the surface of the magnetic recording medium 300. In some aspects, the lubricant layer 316 may be made of a polymer-based or liquid lubricant, for example, from the linear perfluoropolyether (PFPE) class of lubricants that provide excellent tribological and contamination robustness for magnetic recording media. The thickness of the lubricant layer 316 (e.g., a PFPE lubricant film) may be an important parameter in the manufacturing process (e.g., lubrication process) of the magnetic recording medium 300. For example, the thickness of the lubricant layer 316 may need to be controlled down to the one-tenth angstrom (A) scale level.

There are several technologies such as FTIR (Fourier transform infrared spectroscopy), ESCA (Electron spectroscopy for chemical analysis), XRR (X-ray reflectivity), and ellipsometry available for PFPE lubricant film thickness measurement. FTIR can be specifically suitable in magnetic media production due to its easy handling, fast analysis, and robustness even under a harsh environment. For example, FTIR testing can be used to determine the thickness of the lubricant layer 316 (e.g., a PFPE lubricant film) based on spectral characteristics obtained by FTIR testing.

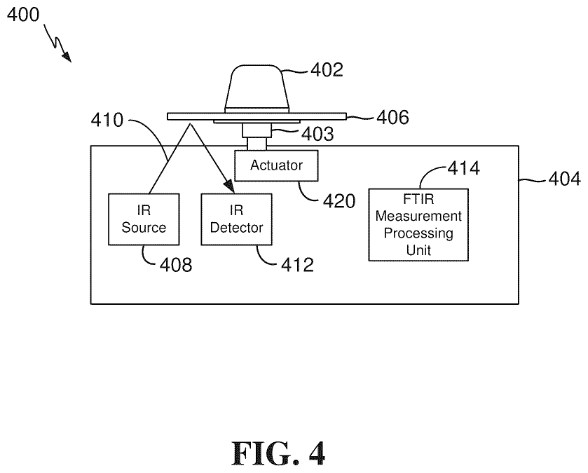

FIG. 4 is a block diagram conceptually illustrating an FTIR measurement apparatus 400 for measuring a film thickness of a magnetic recording medium in accordance with one aspect of the disclosure. The apparatus 400 may include a disk hub 402 that can be connected to an FTIR testing device 404 via a coupler 403. A magnetic recording medium 406 may be loaded on the disk hub 402, for example, after a lubrication process (e.g., possibly one of the last steps in a process for fabricating the magnetic recording medium, such as the medium 300 of FIG. 3). In one example, the magnetic recording medium 406 may be the same as the magnetic recording medium 300 described in relation to FIG. 3. The FTIR testing device 404 may have an infrared (IR) source 408 that can generate and output an IR beam 410 toward a surface (e.g., bottom surface in FIG. 4) of the magnetic recording medium 406. The IR beam 410 is reflected by the bottom surface (e.g., or top surface, either of which having a lubricant layer disposed thereon) of the magnetic recording medium 406 and can be detected by an IR detector 412 for signal processing and analysis using an FTIR measurement processing unit 414. The film thickness of a lubricant layer on the bottom surface of the magnetic recording medium 300 can be characterized or measured by the reflected IR beam 410, for example, proportional to the strength of the reflected IR beam. In one example, the FTIR measurement processing unit 414 can determine the film thickness of the lubricant layer based on a pre-established calibration curve between IR reflection and film thickness.

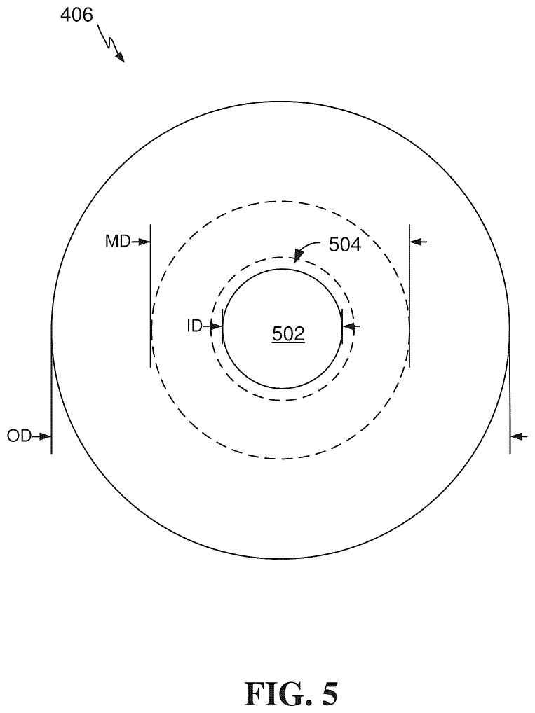

In one example, film thickness data of multiple locations on the media surface can be collected to determine whether the lubricant layer is uniformly applied on the surface of the magnetic recording medium 406. To that end, the disk hub 402 can be configured to rotate the magnetic recording medium 406 to different positions (e.g., 0, 90, 180, and 270 degrees) during the FTIR test so that the IR beam 410 can be reflected from different locations on the bottom surface of the magnetic recording medium 406. The disk hub 402 is made of a material suitable for clean room operations. While the disk hub 402 can be made of metal (e.g., stainless steel), a metal disk hub can easily scratch the surface of the magnetic recording medium 406 during FTIR testing when the recording medium is not secured on the metal disk hub. In general, damage to the recording medium occurs more frequently during loading and unloading of the recording medium as compared to testing. In general, damage to the medium (e.g., during any of the loading, unloading, or testing) occurs on the bottom of the medium and mostly around a disk-to-hub contact area (e.g., area 504 in FIG. 5). For example, the recording medium may rotate about the disk hub when the disk hub rotates to different positions. In that case, scratches can form on the bottom surface of the recording medium 406. In some embodiments, the disk hub 402 is made of a non-metal material that can reduce media damage during FTIR testing. In some embodiments, the disk hub 402 has design features that can increase the friction between the recording medium and the disk hub to prevent or reduce the relative movement (e.g., rotation) of the recording medium about the disk hub. Various embodiments of the disk hub 402 will be described in more detail below.

FIG. 5 is a drawing illustrating the bottom surface of the magnetic recording medium 406 when the medium is installed on the disk hub 402 described in FIG. 4. In some examples, the magnetic recording medium 406 has an annulus shape and one or more layers (e.g., MRL 312) configured for magnetic recording. When the recording medium 406 rotates against the disk hub 402 used for holding and retaining the magnetic recording medium 406 during FTIR testing, surface damages (e.g., scratches) can occur on the media surface. The scratches often occur in an inner diameter area between the insider diameter (ID) of the opening 502 and a middle diameter (MD) of the magnetic recording medium. The MD can locate anywhere between the ID and an outside diameter (OD) of the magnetic recording medium. Furthermore, scratches or damages can occur anywhere between the ID and OD of the magnetic recording medium. Surface damages can also be caused by incidental surface contact between the magnetic recording medium 406 and the disk hub 402 when the magnetic recording medium is installed on the disk hub 402. In addition, any rotation of the magnetic recording medium 406 about the disk hub 402 can introduce scratches (e.g., ring-shaped scratches) in a disk-to-hub contact area (e.g., area 504 in FIG. 5) of the magnetic recording medium 406. In some cases, the scratches can create tiny particles that can reduce the reliability of the magnetic recording medium 406.

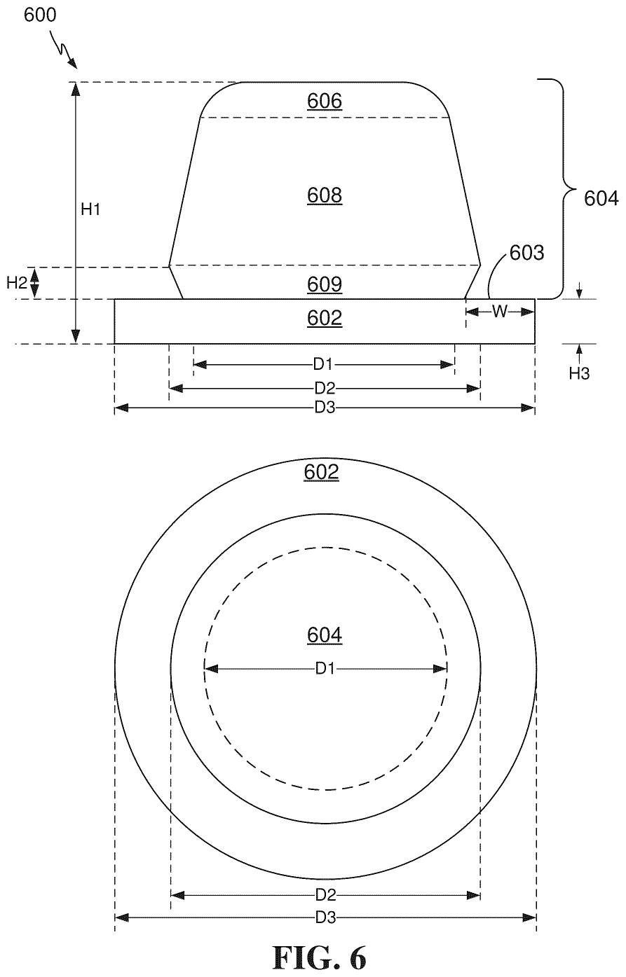

FIG. 6 is a diagram conceptually illustrating a side view and a top view of a disk hub 600 according to one or more aspects of the disclosure. The disk hub 600 may be the same as the disk hub 402 described in relation to FIG. 4. The disk hub 600 may not be drawn in actual scale and some dimensions may be exaggerated for the purpose of illustrating various features of the disk hub 600. The disk hub 600 is different from a typical disk hub (e.g., metal disk hub) in shape and material composition to reduce potential surface damage to a magnetic recording medium during FTIR testing. In some examples, the disk hub 600 can reduce a media scratch rate by up to about 50%, resulting in an increased production yield by about 10%. In some examples, the disk hub 600 can improve the film thickness measurement consistency by up to about 10%.

The disk hub 600 has a suitable height H1 for retaining a magnetic recording medium thereon. In one aspect, the disk hub 600 has a base plate portion 602 and a stem portion 604 on a top side of the base plate portion 602. The stem portion 604 extends in a height direction that is substantially perpendicular to the top side of the base plate portion 602. In some embodiments, the stem portion 604 may have a height of about 2 millimeters (mm) to about 20 mm. The stem portion 604 has a top portion 606, a frustoconical portion 608, and a recessed portion 609.

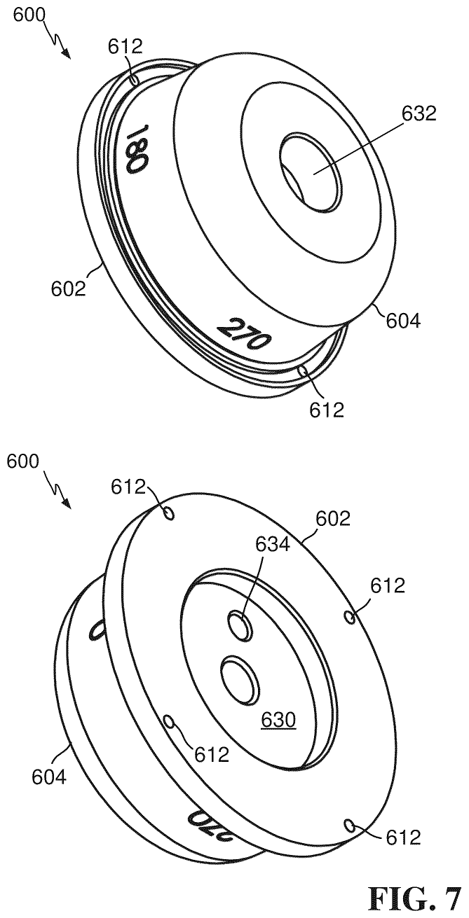

In one embodiment, the recessed portion 609 may have a height (H2 in FIG. 6) that is less than a thickness of a magnetic recording medium held by the disk hub 600 during testing. In some embodiments, the recessed portion 609 may have a thickness of about 0.5 mm or less. The base plate portion 602 forms the bottom or base of the disk hub 600 for supporting and retaining the magnetic recording medium during FTIR testing. In some embodiments, the flange 603 of the base plate portion (e.g., area of the base plate portion 602 beyond the recessed portion 609 in a direction parallel to the length of the base plate portion 602) may have a width (W in FIG. 6) between about 1.5 mm to about 2.5 mm. During testing, the flange 603 is in contact with the disk-to-hub contact area 504 of the magnetic recording medium 406. Therefore, reducing the width or area of the flange 603 can reduce or minimize contamination or damage of the medium. In some aspects, the flange 603 is configured to facilitate suction or vacuum to increase the friction between the flange and the medium. Detail of certain features of the flange 603 for using suction will be described below in relation to FIGS. 7-12. The base plate portion 602 may have a thickness (H3 in FIG. 6) of about 1.1 mm. During FTIR testing and film thickness measurements, the magnetic recording medium 406 rests on the base plate portion 602 with the stem portion 604 extending into the opening 502 (see FIG. 5) of the magnetic recording medium 406.

In one aspect, the frustoconical portion 608 may have different diameters (or radii) at different distances from the base plate portion 602. For example, the frustoconical portion 608 has a first diameter at a first end near the recessed portion 609 and a second diameter at a second end near the top portion 606. The diameter of the frustoconical portion 608 may change gradually from the first diameter to the second diameter. The first diameter (lower diameter) may be larger than the second diameter (upper diameter). The recessed portion 609 may have different diameters (or radii) at different distances from the base plate portion 602. In some aspects, the diameter of the recessed portion 609 may increase (e.g., gradually increase) in a direction away from the base plate portion 602. For example, the diameter of the recessed portion 609 increases from a first diameter (D1) to a second diameter (D2).

The base plate portion 602 may have a diameter (D3 in FIG. 6) suitably sized to improve the stability of the magnetic recording medium during FTIR testing and film thickness measurements when the magnetic recording medium is rotated to different angles or positions.

To reduce potential for media surface damage due to the contact between the media surface and the disk hub, the disk hub 600 can be made of a soft and chemically stable material (e.g., thermoplastic polymer). When the disk hub 600 is made of a material softer than metal (e.g., stainless steel), media surface damage can be reduced or avoided despite contact between the disk hub and the magnetic recording medium under test. In some embodiments, the disk hub 600 may be made of a thermoplastic polymer, for example, in the poly aryl ether ketone (PAEK) family that can be used in various engineering applications. The PAEK family may include poly ether ketone (PEK), poly ether ketone ketone (PEKK), poly ether ether ketone ketone (PEEKK), poly ether ketone ether ketone ketone (PEKEKK), and poly ether ether ketone (PEEK). In one embodiment, the disk hub 600 may be made of a PEEK material. Compared to other materials in the PAEK family, PEEK offers a combination of properties suitable as a disk hub material for the disk hub 600 that is often used in a clean room environment for manufacturing a magnetic recording medium. For example, PEEK has a suitable combination of fatigue resistance and chemical resistance, with good friction as well as wear properties. PEEK also has low moisture absorption, stable dielectric (insulating) properties, good dimensional stability and inherently low flammability. Further, a PEEK material has a crystalline nature that is a desirable property for a disk hub used in FTIR testing performed in a cleanroom setting.

With the above-described properties, a PEEK disk hub can provide stable performance in FTIR testing applications for a long period of time. For example, a PEEK disk hub can maintain FTIR measurement accuracy by effectively eliminating or reducing corrosion, wear, friction, and outgas contaminants from the disk hub for a long period of time. PEEK materials are also versatile in processing which allows the complex geometry of a disk hub to be formed (e.g., molded-in) without using labor intensive post-machining steps used for making a metal disk hub. This, in turn, helps to reduce the cost for fabricating the PEEK disk hub.

In some embodiments, the disk hub 600 can be fabricated with an electrostatic-dissipative material that can dissipate electrostatic charges accumulated on the disk hub and/or the magnetic recording medium safely. In one example, the disk hub 600 can be made of a PEEK material infused with carbon nanotubes. In some embodiments, the PEEK material can be infused with up to about 20% of carbon nanotubes by weight. An electrostatic-dissipative disk hub 600 can reduce the risk of electrostatic discharge between the medium and the disk hub because electrons can slowly flow between the disk hub and the medium without creating an electric arc that can damage the magnetic recording medium. In some embodiments, the PEEK material can be infused with sufficient amount of carbon or metal particles for dispersing static discharges.

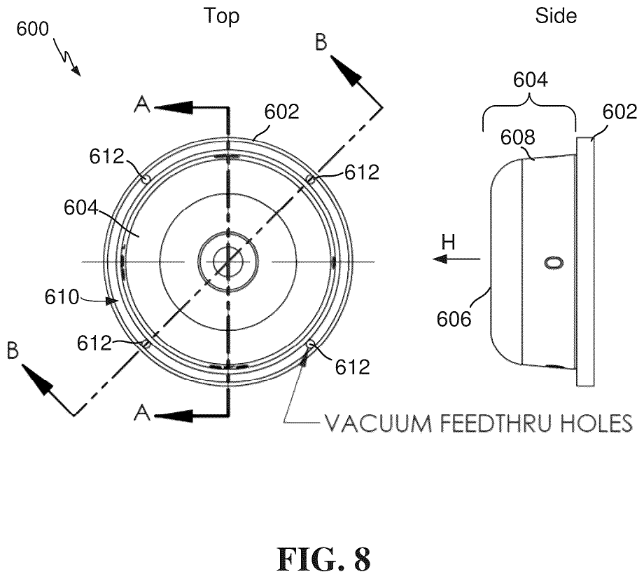

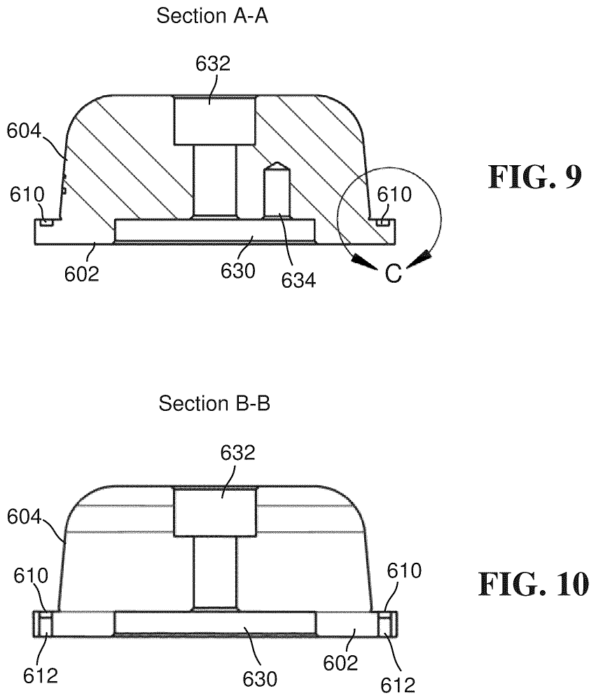

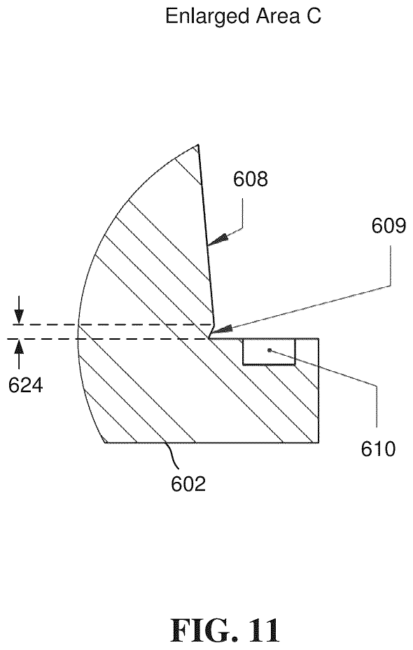

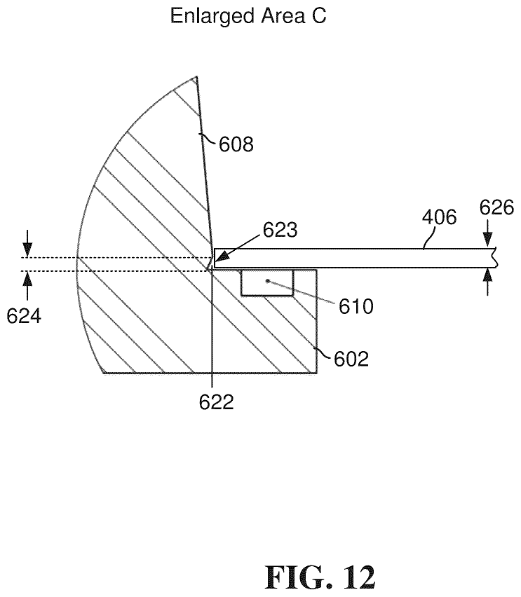

FIGS. 7-12 are diagrams illustrating an embodiment of the disk hub 600. FIG. 7 is a diagram illustrating top and bottom perspective views of the disk hub 600. FIG. 8 is a diagram illustrating a top view and a side view of the disk hub 600. FIG. 9 is a diagram illustrating a view of section A-A (see FIG. 8) of the disk hub 600. FIG. 10 is a diagram illustrating a view of section B-B (see FIG. 8) of the disk hub 600. FIGS. 11 and 12 are diagrams illustrating the enlarged area C (see FIG. 9) of the disk hub 600 in more detail.

In one embodiment, the disk hub 600 has one or more grooves (e.g., a circular groove 610 shown in FIG. 8) formed on the top side of the base plate portion 602. The grooves, in conjunction with vacuum or suction, can improve the seal between the disk hub 600 (e.g., flange 603 of FIG. 6) and the medium. FIGS. 9 and 10 illustrate cross-section views of the exemplary groove 610. When a magnetic recording medium (e.g., medium 406) is placed on the base plate portion 602 (e.g., see FIG. 12), the bottom surface of the medium and the groove 610 can form an air chamber or cavity, that is at least partially enclosed. One or more feedthrough holes (e.g., feedthrough holes 612 shown in FIGS. 7, 8, and 10) can be formed in each groove. Four exemplary feedthrough holes 612 are shown in FIGS. 7 and 8. In one embodiment, the feedthrough holes can be spaced apart along the groove 610 (e.g., at 0, 90, 180, and 270 degrees positions). Each feedthrough hole 612 penetrates through the base plate portion 602 to provide a passage for air to be removed (e.g., by a suction pump) from the groove in order to create a suction to hold the medium down on the base plate portion 602. FIG. 10 illustrates two exemplary feedthrough holes 612 penetrating through the base plate portion 602. When the recording medium is secured on the base plate portion 602 by suction, the medium is less likely to be damaged due to the relative movement between the disk hub and the medium.

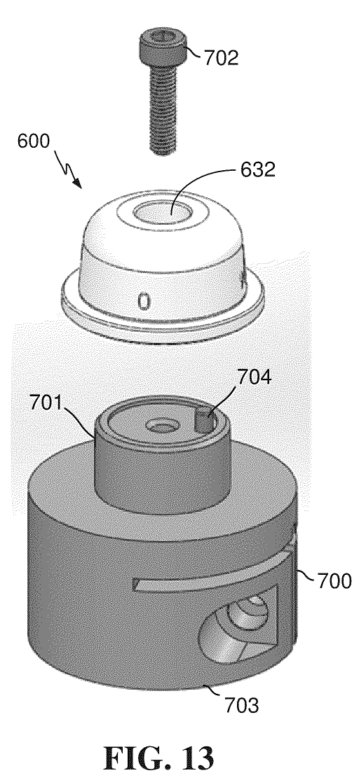

The disk hub 600 can have a center through hole 632 for receiving a fastener (e.g., fastener 702 of FIG. 13). The bottom side of the disk hub 600 can have a cutout or cavity 630 that is dimensioned to receive a coupler (e.g., coupler 700 of FIG. 13). The disk hub 600 can have an opening 634 extending from the cavity 630 for receiving a pin (e.g., pin 704 of FIG. 13) of the coupler. These features will be described in more detail below in relation to FIG. 13.

FIG. 11 is a diagram illustrating an enlarged cross-section area C (see FIG. 9) of the disk hub 600 in more detail. FIG. 12 is a drawing illustrating a portion of a magnetic recording medium (e.g., medium 406) placed on the partially illustrated base plate portion of FIG. 11. The frustoconical portion 608 (a first portion) and the recessed portion 609 (a second portion) of the stem portion 604 are shown in FIGS. 11 and 12. The recessed portion 609 extends between the base plate portion 602 and frustoconical portion 608 of the stem portion 604. In one embodiment, the recessed portion 609 can be formed by a relief cut that can prevent the recording medium from tilting when the medium is put on the disk hub. The recessed portion 609 (e.g., a relief cut) provides a clearance 622 (see FIG. 12) between the inside edge 623 of the recording medium 406 and the stem portion 604. Without the recessed portion 609, a chamfer or fillet may form between the stem portion 604 and the base plate portion 602, and the chamfer can tilt the recording medium. At least a portion of the recessed portion 609 has a diameter smaller than the largest diameter of the frustoconical portion 608. In this example, the recessed portion is located at the lower part of the stem portion 604 and is adjacent to the base plate portion 602. In one aspect, a height 624 of the recessed portion 609 (e.g., relief cut) is designed to be less than a thickness 626 (see FIG. 12) of the recording medium 406. In some aspects, the frustoconical portion 608 may have an increasing diameter starting from a smaller diameter at the top and increasing to a larger diameter toward the base plate portion. The recessed portion 609 has an increasing circumference starting from a smaller diameter and increasing to a larger diameter away from the base plate portion 602. In some embodiments, the recessed portion 609 can have a flat contour, a concave contour, or a convex contour. The recessed portion 609 and the base plate portion 602 can form an acute angle (e.g., 90 degrees or less) at their junction.

In some aspects, the base plate portion 602 has dimensions suitably sized to improve the consistency of film thickness measurements when the magnetic recording medium 406 is rotated to different positions (e.g., 0, 90, 180, and 270 degree positions) by the hub 600. In some embodiments, the base plate portion 602 may have a diameter between about 25 mm and about 30 mm, inclusive. In some embodiments, the diameter of the stem portion 604 may be between about 20 mm and about 25 mm, inclusive. In some embodiments, the diameter of the base plate portion 602 may be larger than the diameter of the stem portion, for example, by about 2.5 mm or less. In one example, the base plate portion 602 can form a flange or rim with a width of about 2.5 mm or less around the stem portion 604. Using a smaller rim can reduce the possibility of contamination and/or damage of the medium by the disk hub during testing.

In some embodiments, the disk hub 600 can be designed to be detachable from the FTIR measurement apparatus 400. A detachable disk hub can facilitate easy replacement and/or the use of different hub designs (e.g., shape and/or size) for different media. For example, the disk hub 600 can be installed on the FTIR measurement apparatus 400 via a coupler (e.g., coupler 403) that allows the disk hub 600 to be easily removed and replaced without removing the coupler.

FIG. 13 is a drawing illustrating the disk hub 600 connected to a coupler 700. The coupler 700 may be the same as the coupler 403 of FIG. 4. In some embodiments, the bottom side of the disk hub 600 has a cutout or cavity 630 (see FIGS. 9 and 10) that is dimensioned to receive one end 701 of the coupler 700, and another end 703 of the coupler 700 can be connected to an actuator 420 (FIG. 4) of the FTIR measurement apparatus 400 that may rotate the coupler to various positions during thickness measurements. In one embodiment, the disk hub 600 can be secured to the coupler 700 by a fastener 702 (e.g., a screw or bolt) and a pin 704 that prevents the disk hub from rotating apart from the coupler 700. For example, the disk hub 600 has a center through hole 632 for receiving the fastener 702 and an opening 634 (see FIG. 7) extending from the cavity 630 for receiving the pin 704 of the coupler.

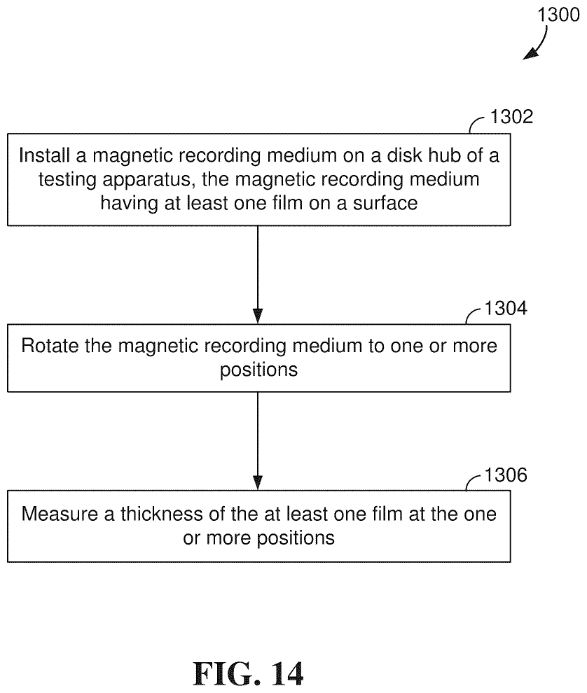

FIG. 14 is a flowchart illustrating a process 1300 for measuring a film thickness of a magnetic recording medium using the disk hub 600 in accordance with some aspects of the disclosure. In one example, process 1300 can be used to measure a film thickness of the magnetic recording medium 406 using the apparatus 400. At block 1302, a magnetic recording medium can be installed on the disk hub of an FTIR testing apparatus, and the magnetic recording medium has at least one film (e.g., a lubricant layer 316) on a media surface. For example, the testing apparatus may be the FTIR measurement apparatus 400 described above in relation to FIG. 4. The disk hub may be the same as the disk hub 600 described in relation to the figures. In one example, the disk hub may be made of a soft electrostatic-dissipative material (e.g., a PEEK material infused with carbon nanotubes) that can reduce potential damages to the magnetic recording medium by electrostatic discharges during an FTIR measurement process. At block 1304, the magnetic recording medium is rotated to one or more positions (e.g., angular positions at 0, 90, 180, and 270 degrees). At block 1306, the apparatus 400 can measure a thickness of at least one film (e.g., a lubricant film) of the magnetic recording medium at one or more positions.

In one embodiment, the above described process can perform the sequence of actions in a different order. In another embodiment, the process can skip one or more of the actions. In other embodiments, one or more of the actions are performed simultaneously. In some embodiments, additional actions can be performed.

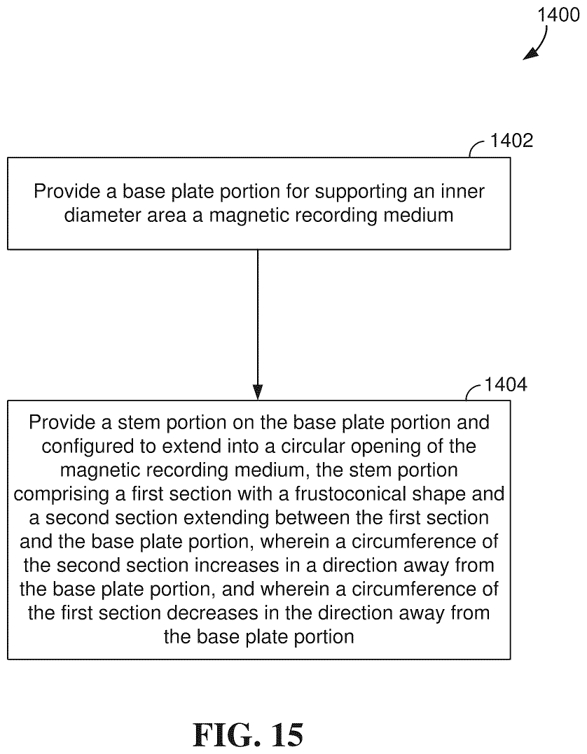

FIG. 15 is a flowchart illustrating a process 1400 for manufacturing a disk hub in accordance with some aspects of the disclosure. The process 1400 may be used to manufacture the disk hub 600 described above for retaining a magnetic recording medium during FTIR testing. In one embodiment, the method can form the disk hub using a soft electrostatic-dissipative material, for example, a thermoplastic polymer (e.g., PEEK) infused with carbon nanotubes.

At block 1402, the method forms the disk hub to provide a base plate portion for supporting an inner diameter area of the magnetic recording medium. At block 1404, the method forms the disk hub to provide a stem portion on the base plate portion. The stem portion is configured to extend into a circular opening (e.g., opening 502 of FIG. 5) of the magnetic recording medium. The stem portion has a first section (e.g., frustoconical portion 608 of FIG. 6) with a frustoconical shape and a second section extending between the first section and the base plate portion. The circumference of the second section increases in a direction away from the base plate portion. The circumference of the first section decreases in a direction away from the base plate portion. In one embodiment, the second section may be the recessed portion 609 described above that can provide a clearance (e.g., relief cut) between the recording medium and the stem portion. The clearance can prevent a chamfer or fillet (e.g., a reversed fillet) from being formed between the base plate portion and the stem portion. The chamfer/fillet when present can tilt the magnetic recording medium during testing.

The terms “above,” “below,” and “between” as used herein refer to a relative position of one layer with respect to other layers. As such, one layer deposited or disposed above or below another layer may be directly in contact with the other layer or may have one or more intervening layers. Moreover, one layer deposited or disposed between layers may be directly in contact with the layers or may have one or more intervening layers.

Various components described in this specification may be described as “including” or “comprising” or made of certain materials or compositions of materials. In one aspect, this can mean that the component consists of the particular material(s). In another aspect, this can mean that the component comprises the particular material(s).

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. It is further noted that the term “over” as used in the present application in the context of one component located over another component, may be used to mean a component that is on another component and/or in another component (e.g., on a surface of a component or embedded in a component). Thus, for example, a first component that is over the second component may mean that (1) the first component is over the second component, but not directly touching the second component, (2) the first component is on (e.g., on a surface of) the second component, and/or (3) the first component is in (e.g., embedded in) the second component. The term “about ‘value X’”, or “approximately value X”, as used in the disclosure shall mean within 10 percent of the ‘value X’. For example, a value of about 1 or approximately 1, would mean a value in a range of 0.9-1.1. In the disclosure various ranges in values may be specified, described and/or claimed. It is noted that any time a range is specified, described and/or claimed in the specification and/or claim, it is meant to include the endpoints (at least in one embodiment). In another embodiment, the range may not include the endpoints of the range.

It shall be appreciated by those skilled in the art in view of the present disclosure that although various exemplary fabrication methods are discussed herein with reference to magnetic recording disks, the methods, with or without some modifications, may be used for fabricating other types of recording disks, for example, optical recording disks such as a compact disc (CD) and a digital-versatile-disk (DVD), or magneto-optical recording disks, or ferroelectric data storage devices.

While the above description contains many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents.

What is claimed is:

1. A disk hub for retaining a magnetic recording medium comprising an annulus shape and a layer configured for magnetic recording, the disk hub comprising:
a base plate portion configured to support an inner diameter area of the magnetic recording medium; and
a stem portion on the base plate portion and configured to extend into a circular opening of the magnetic recording medium,
the stem portion comprising a first section with a frustoconical shape and a second section extending between the first section and the base plate portion, wherein a circumference of the second section increases in a direction away from the base plate portion, and wherein a circumference of the first section decreases in the direction away from the base plate portion.

2. The disk hub of claim 1, wherein a height of the second section between the first section and the base plate portion is less than a thickness of the magnetic recording medium.

3. The disk hub of claim 1, wherein the base plate portion comprises one or more feedthrough holes on a surface of the base plate portion configured to support the magnetic recording medium.

4. The disk hub of claim 3, wherein the base plate portion comprises at least one groove in the surface of the base plate portion, the at least one groove connected with the one or more feedthrough holes.

5. The disk hub of claim 1, wherein the second section and the base plate portion form an acute angle at a junction therebetween.

6. The disk hub of claim 1, wherein the stem portion comprises a material with a hardness less than that of stainless steel.

7. The disk hub of claim 6, wherein the material comprises an electrostatic dissipative material.

8. The disk hub of claim 7, wherein the electrostatic dissipative material is infused with carbon nanotubes.

9. The disk hub of claim 7, wherein the material comprises a thermoplastic or poly ether ether ketone (PEEK).

10. An apparatus for characterizing a magnetic recording medium for a data storage device, comprising:
the disk hub of claim 1; and
an actuator coupled to the disk hub and configured to rotate the disk hub and the magnetic recording medium positioned thereon to one or more positions for film thickness measurements of the magnetic recording medium.

11. A method of manufacturing a disk hub for retaining a magnetic recording medium comprising an annulus shape and a layer configured for magnetic recording, the method comprising:
forming the disk hub using a thermoplastic polymer, comprising,
providing a base plate portion configured to support an inner diameter area of the magnetic recording medium; and
providing a stem portion on the base plate portion and configured to extend into a circular opening of the magnetic recording medium,
the stem portion comprising a first section with a frustoconical shape and a second section extending between the first section and the base plate portion, wherein a circumference of the second section increases in a direction away from the base plate portion, and wherein a circumference of the first section decreases in the direction away from the base plate portion.

12. The method of claim 11, wherein a height of the second section between the first section and the base plate portion is less than a thickness of the magnetic recording medium.

13. The method of claim 11, wherein the base plate portion comprises one or more feedthrough holes on a surface of the base plate portion configured to support the magnetic recording medium.

14. The method of claim 13, wherein the base plate portion comprises at least one groove in the surface of the base plate portion, the at least one groove connected with the one or more feedthrough holes.

15. The method of claim 11, wherein the second section and the base plate portion forms an acute angle at a junction therebetween.

16. The method of claim 11, wherein the stem portion comprises a material with a hardness less than that of stainless steel.

17. The method of claim 16, wherein the material comprises an electrostatic dissipative material.

18. The method of claim 17, wherein the electrostatic dissipative material is infused with carbon nanotubes.

19. The method of claim 17, wherein the material comprises a thermoplastic or poly ether ether ketone (PEEK).

20. A disk hub for retaining a magnetic recording medium comprising an annulus shape and a layer configured for magnetic recording, the disk hub comprising:
a base plate portion for supporting an inner diameter area of the magnetic recording medium; and
a stem portion on the base plate portion and configured to extend into a circular opening of the magnetic recording medium,
wherein the disk hub comprises an electrostatic dissipative material.

21. The disk hub of claim 20, wherein the electrostatic dissipative material is infused with carbon nanotubes.

22. The disk hub of claim 20, wherein the electrostatic dissipative material comprises a thermoplastic or poly ether ether ketone (PEEK).

23. The disk hub of claim 20, wherein the electrostatic dissipative material comprises a poly ether ether ketone (PEEK) material infused with carbon nanotubes.
